(19) United States
(12) Patent Application Publication
(10) Pub. No.: US 2013/0332882 A1
(43) Pub. Date: Dec. 12, 2013

(54) CONTEXT BASED DESKTOP ENVIRONMENT FOR CONTROLLING PHYSICAL SYSTEMS

(71) Applicants: GRAEME LAYCOCK, HUNTERS HILL (AU); ROHAN MCADAM, YETHOLME (AU); STEPHEN COOREY, STRATHFIELD (AU); CARY LI, EASTWOOD (AU)

(72) Inventors: GRAEME LAYCOCK, HUNTERS HILL (AU); ROHAN MCADAM, YETHOLME (AU); STEPHEN COOREY, STRATHFIELD (AU); CARY LI, EASTWOOD (AU)

(73) Assignee: HONEYWELL INTERNATIONAL INC., Morristown, NJ (US)

(21) Appl. No.: 13/492,539

(22) Filed: Jun. 8, 2012

(51) Int. Cl. G06F 3/048

(52) U.S. Cl. 715/783

(57) ABSTRACT

A method for providing an operational context-based desktop environment for a physical system. The method includes displaying a desktop comprising a plurality of regions, each of the plurality of regions representing a different operational context of the physical system, and wherein the plurality of regions include visual indicia corresponding to their operational context, visual indicia of one or more active graphical user interfaces corresponding to the operational context and visual indicia of dynamic operational data corresponding to the operational context. The method further includes enlarging the active graphical user interfaces corresponding to the operational context of the region, responsive to user activation of a first region. The plurality of regions can be arranged according to a physical layout of the physical system or as a flow sheet reflecting an order of process steps for a process run by the physical system.

### FIELD

Disclosed embodiments relate to the field of virtual desktop environments, and more particularly to virtual desktop environments for controlling physical systems including physical processes.

### BACKGROUND

Physical systems involve at least the transport of a tangible (i.e. real) product, while physical processes further involve the manufacture of a tangible product from one or more materials. The physical system may be a large geographically dispersed system (e.g., a gas pipeline) or complex multi-step process (e.g., for a large oil refinery). Physical systems may be contrasted with virtual systems which lack association with movement or processing of any tangible (i.e. real) materials.

The physical system may comprise a process automation system which refers to a monitoring and control system, usually of an industrial system running a set of industrial processes that generate a physical (tangible) product, in which a distributed control system (DCS) may utilize controller elements to monitor and control the industrial processes. With regard to monitoring, the industrial processes generate process data (e.g., temperatures, pressures) that is transmitted to the DCS, often in real time. The DCS subsequently displays the process data for human operators that monitor and control the industrial process via graphical user interfaces displayed in a console. The components of the process automation system may be connected by a process control communications network.

The control including operation and management of physical systems including industrial processes often involves the use of a large number of software applications that collectively provide information from a wide variety of different sources. The particular software applications used and the information viewed in those software applications at any given time depend on the current operational focus, which can change from moment to moment. For example, at one moment, the operator may desire to view data pertaining to a particular electrical system while at another moment the operator may desire to view locations within an industrial plant. Thus, the operator's focus may change according to the operational context of the information he or she desires to monitor and control.

A known data selection approach involves having the operator locate and open software applications that pertain to the operational context he or she desires. The time required for the operator to find and open the relevant software applications and navigate to the desired data can be a substantial impediment to efficiently dealing with urgent situations or crises as they may arise. Additionally, when the operator's focus shifts temporarily from a first operational context to a new operational context, the operator may need to shut down the first set of software applications pertaining to the first operational context and locate and open a second set of software applications pertaining to the second operational context. When the operator's focus then changes back to the first operational context, he or she must perform a reverse procedure. Such operational context switching can be tedious and time consuming. Therefore, there is a need for a more efficient method and system for controlling physical systems.

### SUMMARY

Disclosed embodiments include a method for providing an operational context-based desktop environment for a physical system. The method includes displaying a desktop comprising a plurality of regions, including a plurality of different operational contexts for the system. Each region includes visual indicia corresponding to the operational context of the region, visual indicia of one or more active graphical user interfaces (GUIs) corresponding to the operational context of the region, and visual indicia of dynamic operational data corresponding to the operational context of the region. The method can further include enlarging the active GUIs corresponding to the operational context of a region, responsive to user activation of the region.

As used herein, “operational context” refers to a concept that can be used to relate data or facts that surround a particular location in the physical system, or a process step, element, event, situation, sub-system or sub-process of the physical system being controlled. For example, the operational context “Compressor Station 1” can be used relate facts and data that surround a particular compressor station on a gas pipeline. Further, the terms “process event data” or “process data” refer to data, such as log messages, incident data, sensor data or the like, originating from physical processes. Process data may include a scalar or array value, a date/time stamp, an error message or other data surrounding the process being monitored. Process event data may be in the form of a text message, image, audio or video. In addition, as used herein “dynamic operational data” refers to process data or process event data obtained from the physical system, typically physical parameter data from a sensor that represents the current state of a process, such as a pressure reading from a valve or a temperature reading from a thermocouple. The dynamic operational data is updated as the state of the process changes, thereby providing an indication of how the process changes over time.

Further disclosed embodiments include a process automation system comprising an operational context-based desktop environment. The process automation system comprises a display configured for displaying a desktop comprising a plurality of regions, wherein each region corresponds to an operational context of the process automation system. Each region includes visual indicia corresponding to the operational context of the region, visual indicia of one or more active graphical user interfaces corresponding to the operational context of the region, and visual indicia of dynamic operational data corresponding to the operational context of the region. The process automation system can further comprise a processor configured for controlling one or more physical processes, and, responsive to user activation of a region, enlarging the active graphical user interfaces corresponding to the operational context of the region. The process automation system can further comprise memory comprising non-transitory machine readable storage for storing the dynamic operational data from the physical processes.

### BRIEF DESCRIPTION OF THE DRAWINGS

FIG. 1 is a block diagram of an example control system including a distributed control system (DCS) employing an operational context-based desktop environment, according to an example embodiment.

FIG. 2 depicts an operational context-based desktop environment for a control system, according to an example embodiment.

FIG. 3 depicts a second portion of the operational context-based desktop environment of FIG. 1.

FIG. 4 depicts the operational context-based desktop environment of FIG. 1, including an enlarged set of active graphical user interfaces.

FIG. 5 is a flow chart illustrating the control flow of an example method for providing an operational context-based desktop environment for a physical system, according to an example embodiment.

### DETAILED DESCRIPTION

Disclosed embodiments are described with reference to the attached figures, wherein like reference numerals are used throughout the figures to designate similar or equivalent elements. The figures are not drawn to scale and they are provided merely to illustrate certain disclosed aspects. Several disclosed aspects are described below with reference to example applications for illustration. It should be understood that numerous specific details, relationships, and methods are set forth to provide a full understanding of the disclosed embodiments. One having ordinary skill in the relevant art, however, will readily recognize that the subject matter disclosed herein can be practiced without one or more of the specific details or with other methods. In other instances, well-known structures or operations are not shown in detail to avoid obscuring certain aspects. This Disclosure is not limited by the illustrated ordering of acts or events, as some acts may occur in different orders and/or concurrently with other acts or events. Furthermore, not all illustrated acts or events are required to implement a methodology in accordance with the embodiments disclosed herein.

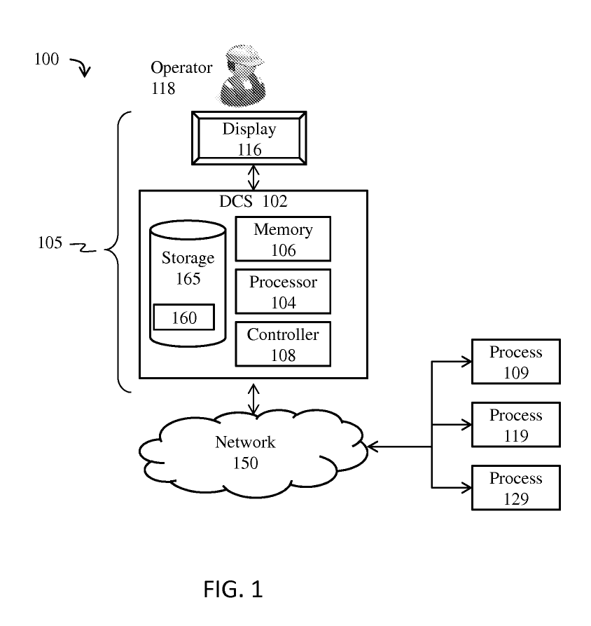

Disclosed embodiments include control systems which provide an operational context-based desktop environment to control physical systems. FIG. 1 is a block diagram of a controlled physical system 100 including a disclosed control system 105 comprising a distributed control system (DCS) 102 employing an operational context-based desktop environment displayed on a display 116, according to an example embodiment.

DCS 102 is communicably connected via a process control network 150 to industrial processes 109, 119 and 129, which represent physical processes performed by a physical system. The DCS 102 includes at least one processor 104, at least one memory 106 providing non-transitory machine readable data storage to the processor 104, and one or more controllers 108 that provide control signals for controlling the industrial processes 109, 119 and 129. Furthermore, DCS 102 is associated with display 116, to which the DCS 102 sends data (e.g., process data and/or dynamic operational data) about the industrial processes 109, 119 and 129 it monitors and controls. The display 116 displays information in an operational context-based desktop environment for viewing by a human operator 118 as described more fully below.

Recall the terms “process event data” or “process data” as used herein refer to data originating from physical processes, such as industrial processes 109, 119 and 129. Also note that the controlled physical system 100 depicted in FIG. 1 supports any number of DCSs, any number of processors 104 and controllers 108 within the DCS 102, any number of displays 116 associated with the DCS 102, and any number of industrial processes associated with the DCS 102.

The processor 104 is configured to receive process data and/or dynamic operational data from the plurality of industrial process 109, 119 and 129 and store the processed data in memory 106, and in another memory provided by non-transitory machine readable storage media 165 which includes a stored database 160, such as a relational database. A relational database as used herein is a database that matches data by using common characteristics found within the data set, and the resulting groups of data are organized for ease of understanding. Such a grouping uses the relational model. Accordingly such a database is called a “relational database.” The software used to do this grouping is generally called a relational database management system (RDBMS). The database 160 may comprise a Structured Query Language (SQL) database stored in a SQL server. SQL can be employed to access data, and also to define the form of the database, i.e., describe the tables, and describe indexes and views of the tables and other objects of the database. SQL is a high level programming language specifically designed for the database product.

Display 116 may comprise a graphical display, or an area of a graphical display, in a physical monitor, viewing screen, flat panel display, touch screen or the like. The display 116 may generate graphical user interfaces (GUIs) and other visual indicia that display process data garnered from the industrial processes of controlled system 100 for viewing by human operator 118. The display 116 may be provided by a computer system having a processor, and user input devices, such as a keyboard, mouse, touch screen and/or a microphone.

A desktop environment commonly refers to a particular implementation of GUI derived from the desktop metaphor that is seen on most modern personal computers. A desktop environment allows users to easily access, configure, and modify important and frequently accessed specific operating system features. A desktop environment typically consists of icons, windows, toolbars, folders, wallpapers and desktop widgets or applications. A desktop refers to a particular instance of a desktop environment graphical user interface window.

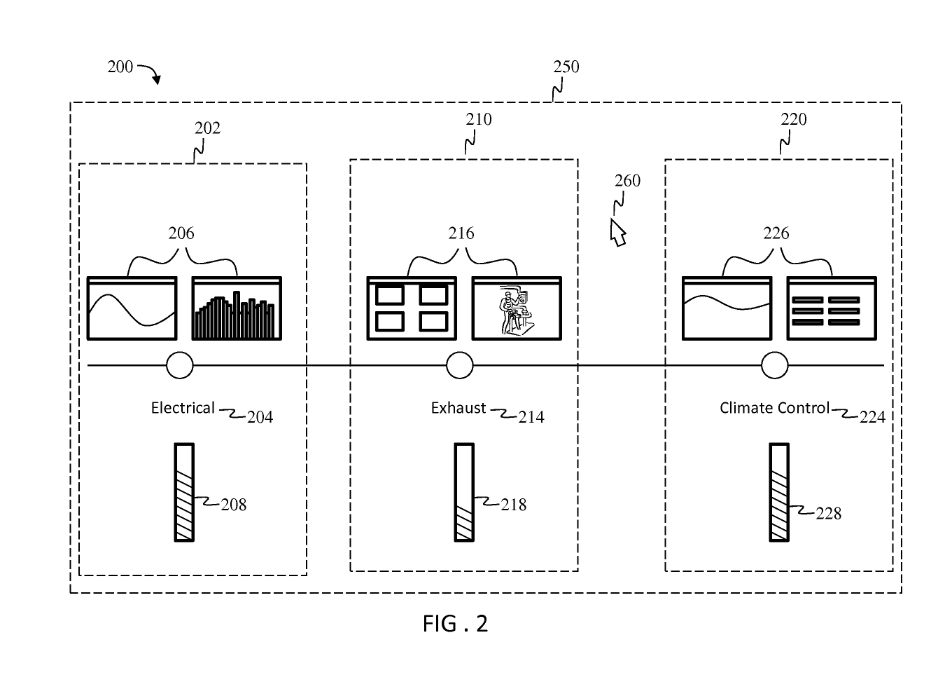

FIG. 2 depicts an operational context-based desktop environment 200 or a portion thereof (hereafter desktop 200), such as for the display 116 shown in control system 105, according to an example embodiment. Desktop 200 is viewable in an area 250 of the display 116, otherwise known as a viewable area 250. The desktop 200 comprises one or more regions 202, 210 and 220, that each define a section of the desktop 200. A region may also be defined as one or more GUI images, icons or widgets. Each region corresponds to an operational context of the controlled physical system 100. As defined above, an operational context refers to a set of related circumstances, data or facts that surround a particular location, process, element, event, situation, sub-system or sub-process of the physical system being controlled. An example of an operational context is a particular location or area of the physical system, wherein an operator 118 may desire to view all process data that relates to a particular location of an industrial process or system.

Each region 202, 210, 220 of the desktop 200 includes visual indicia corresponding to the operational context of the region, visual indicia of one or more active GUIs corresponding to the operational context of the region and visual indicia of dynamic operational data corresponding to the operational context of the region. Thus, region 202, for example, includes visual indicia 204 corresponding to the electrical operational context of the region, visual indicia 206 of two active GUIs corresponding to the electrical operational context and visual indicia 208 of dynamic operational data and/or process data corresponding to the electrical operational context. Likewise, region 210 includes visual indicia 214 corresponding to the exhaust operational context, visual indicia 216 of two active GUIs corresponding to the exhaust operational context and visual indicia 218 of dynamic operational data corresponding to the exhaust operational context. Lastly, region 220 includes visual indicia 224 corresponding to the climate control operational context, visual indicia 226 of two active GUIs corresponding to the climate control operational context and visual indicia 228 of dynamic operational data corresponding to the climate control operational context.

The visual indicia 204, 214 and 224 corresponding to the operational context of their region, such as 202, 210 and 220, may comprise text, an image, video or a combination thereof. The visual indicia 204, 214 and 224 corresponding to the operational context of a region may comprises any information that quickly conveys to an operator 118, in a visual, manner, the operational context of the information in the region.

The visual indicia 206, 216, 226 of one or more active GUIs corresponding to the operational context of a region, such as 204, 214 and 224, may comprise text, an image, a thumbnail of the active GUIs, video or a combination thereof. The visual indicia 206, 216, 226 of active GUIs may comprises any information that quickly conveys to an operator 118, in a visual, manner, the identity, and/or information present within, each GUI that is currently active with regard to a particular operational context.

A GUI or application window refers to a visual area, usually having a rectangular shape, which can overlap with the area of other GUIs or application windows. A GUI or application window displays output from, and may allow input to, one or more computer programs or processes of the DCS 102. A GUI or application window may also display out from, and allow input to, computer programs or processes executing apart from the DCS 102. An active GUI or application window refers to a GUI or application window for a computer program or process that is currently being executed by a processor, such as processor 104. The visual indicia 206, 216 and 226 of one or more active GUI may display output from the processes 109, 119, 129, and may allow input to controller 108 for controlling processes 109, 119, 129.

Lastly, visual indicia of dynamic operational data corresponding to the operational context of the region, such as indicia 208, 218 and 228, may comprise text, an image, video or a combination thereof. Dynamic operational data refers to data from the physical system, typically from a sensor, that may be periodically updated by DCS 102, such as a pressure reading from a valve or a temperature reading from a thermocouple. In FIG. 2, the indicia 208, 218 and 228 depict a generic image representing a measuring device, or meter, which may display dynamic operational data that is received by processor 104 and stored in memory 106.

Note that although FIG. 2 shows only a given number of elements, disclosed desktops support any number of regions, visual indicia corresponding to operational context, visual indicia of one or more active graphical user interfaces and visual indicia of dynamic operational data.

In one embodiment, the arrangement of the various regions 202, 210, 220 in relation to one another in the desktop 200 corresponds to a process map of an actual physical process, such as in the case of a processing system. A process map is a visual representation of a series of processes that are illustrated so as to show the sequential nature of the processes. In this embodiment, regions adjacent to one another in the desktop 200 correspond to processes that may occur sequentially in a process map. For example, the operational context of region 210 may represent one or more processes that occur sequentially after the one or more processes represented by the operational context of region 202. Thus, region 210 is displayed to the right of region 202, so as to indicate that the processes of region 210 occur after the processes of region 202.

Arranging regions on the desktop 200 according to the physical layout of the plant or the order of process or manufacturing steps, such as a flow sheet reflecting an order of process steps for a process run by the physical system, can make it significantly easier for the operator to navigate through the various regions 202, 210, 220 based on their knowledge of plant layout or manufacturing processes. This advantage is a reason disclosed desktops such as desktop 200 are configured as a large continuous space as opposed to a plurality of discrete desktops. The layout of various regions 202, 210, 220 regions in this embodiment is meaningful as it is a significant aid to facilitate finding information and switching contexts.

In another embodiment, the arrangement of the various regions 202, 210, 220 in relation to one another in the desktop 200 corresponds to actual physical locations/areas relative to one another in a physical system that is dispersed over an area, such as a gas line network dispersed over geographic regions. In this embodiment, regions adjacent to one another in the desktop 200 correspond to systems or equipment that are located physically adjacent to one another in a location map, which is a visual representation of systems and equipment that are illustrated so as to show their physical locations. For example, the operational context of region 302 may represent equipment that is located physically adjacent the equipment represented by the operational context of region 310. Therefore, region 302 is displayed adjacent to region 310, so as to indicate that the equipment of region 302 is physically adjacent to the equipment of region 310. Arranging regions in this way on the desktop 200 makes it easier for the operator 118 to navigate to a required region based on the operator's knowledge of the sequential order of production processes and/or the physical layout of a process plant.

An operator 118 may interact with the desktop 200 using a conventional pointer or mouse cursor, which is a graphical image that echoes movements of a pointing device, such as a mouse, a touchpad or a touch screen. The pointer 260 can be used to select and move, such as via the conventional drag and drop method, other graphical user interface elements. FIG. 2 shows a pointer 260 appearing as an angled arrow. However, the image of the pointer 260 may vary. In one embodiment, the pointer 260 may appear in a clear focus state, wherein the pointer 260 appears solely when the pointing device is touched or moved by the operator 118.

In one embodiment, the viewable area 250 displays only a portion of the data or images of desktop 200. In this embodiment, the desktop 200 may be panned such that the viewable area 250 of the desktop 200 changes. The operator 118 may click on the desktop 200 using the pointer 260 and use the drag and drop method to move the viewable area 250 of the desktop 200 and thereby view additional graphical elements, such as additional regions, not found in viewable area 250. In this embodiment, the processor 104 reads panning commands or panning input from the operator 118, such as via pointer 260, and thereby moves the viewable area 250 of the desktop 200 to a new viewable area defined by the user's commands or input.

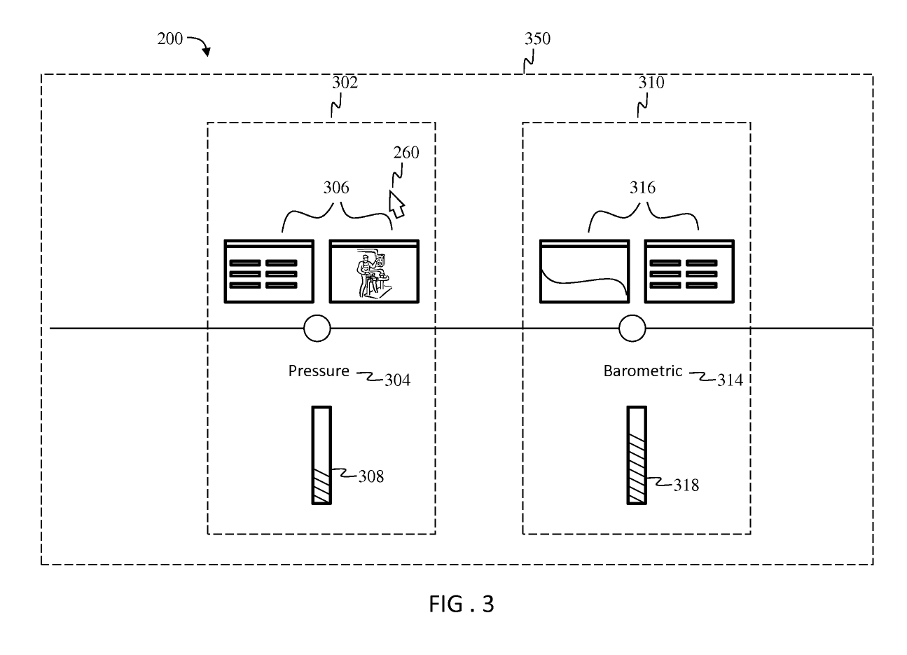

FIG. 3 shows a second portion of the desktop 200 referred to as viewable area 350 that includes regions not shown in viewable area 250. Viewable area 350 includes region 302, which comprises visual indicia 304 corresponding to a pressure operational context of the process automation system 100, visual indicia 306 of one or more active GUIs corresponding to the pressure system operational context and visual indicia 308 of dynamic operational data corresponding to the pressure operational context. Viewable area 350 also includes region 310, which comprises visual indicia 314 corresponding to the barometric operational context, visual indicia 316 of one or more active GUIs corresponding to the barometric operational context and visual indicia 318 of dynamic operational data corresponding to the barometric operational context.

In one embodiment, the operator 118 may activate a region, such as region 302, by positioning the pointer 260 over the region 302 (or a portion thereof) and clicking a mouse or tapping a touch screen. In response to the aforementioned user activation of region 302, the processor 104 of DCS 102 may enlarge or maximize the visual indicia 306 of active GUIs of the region. A user activation may also be accomplished using other user input instructions, such as hovering the pointer 260 over the region 302, passing the pointer 260 over the region 302, clicking on another widget, issuing a voice command or performing a gesture.

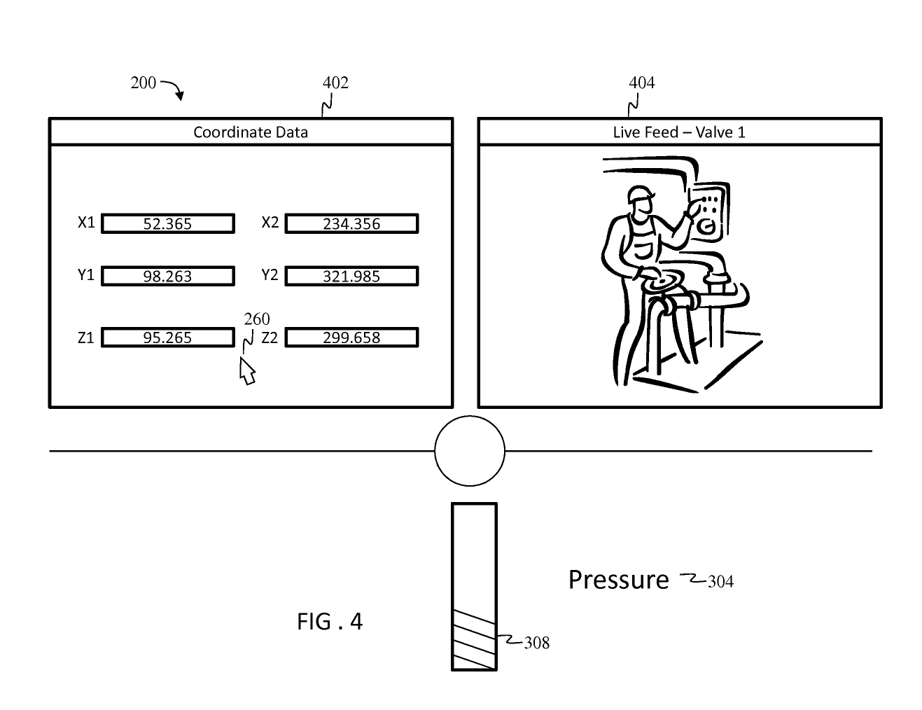

FIG. 4 shows an enlarged set of active GUIs 402, 404 in response to the aforementioned user activation. Upon enlarging or maximizing the active GUIs 402, 404, the processor 104 of DCS 102 may also initiate the active GUIs 402, 404 to accept user input. Alternatively, the processor 104 of DCS 102 may initiate the active GUIs 402, 404, to accept user input in response to an additional user activation event. Subsequently, the operator 118 may interact with the active GUIs 402, 404, which may function to monitor, control to modify the processes 109, 119 and 129. Specifically, operator 118 may input data into, and receive data (such as process data) from, the active GUIs 402, 404. Further, the operator 118 may use conventional GUI commands to open, close, minimize, maximize, move, or resize the active GUIs 402, 404. FIG. 4 further shows that processor 104 of DCS 102 has also enlarged or maximized in visual size the visual indicia 304 and the visual indicia 308.

In one embodiment, the operator 118 may activate the region 302 a second time, in an identical or similar fashion to the first user' activation. In response to the aforementioned user activation of region 302, the processor 104 of DCS 102 may downsize or minimize the active visual indicia 306 of active GUIs of the region, returning the appearance of desktop 200 to that shown in FIG. 3.

The desktop 200 improves over known desktops by providing a computing environment in which active GUIs are opened and managed in a desktop that categorizes the GUIs by operational context. The desktop 200 may comprise a continuous space through which an operator 118 can easily navigate with conventional GUI commands among the various operational contexts of interest. GUIs are opened and can remain active on the desktop 200, though minimized and visually categorized by operational context for easy lookup by the user. The operator 118 may easily view the desktop 200 and quickly ascertain the operational context of each region in the viewable area (i.e., indicia 208, 218, 228), the active graphical user interfaces in each region (i.e., indicia 206, 216, 226) and selected dynamic operational data (i.e., 208, 218, 228).

Further, desktop 200 allows a user to quickly maximize and minimize active GUIs in each region, while keeping the interfaces active. This allows an operator 118 to navigate to a different operational context in order to use active GUI, or open new GUIs, relevant to the operational context. Subsequently, the operator 118 can easily navigate back to the original operational context and the active GUI associated with the original operational context.

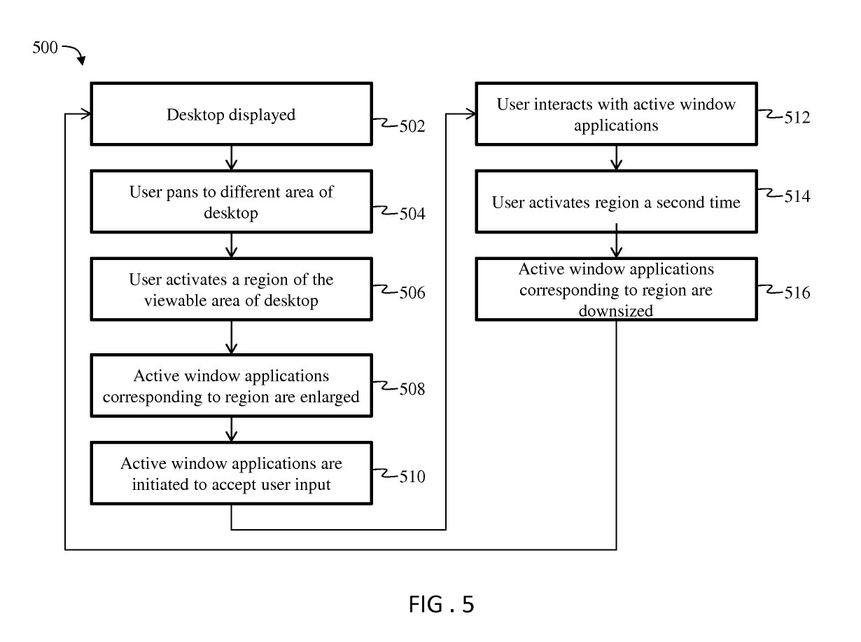

FIG. 5 is a flow chart illustrating the control flow of an example method 500 for providing an operational context-based desktop environment for a physical system, such as process automation system 100, according to an example embodiment. In a first step 502, the processor 104 of DCS 102 displays the desktop 200, such as that shown in FIG. 2, including the viewable area 250. In an optional step before step 502, the operator 118 may input data into DCS 102 defining one or more operational contexts, one or more regions, one or more visual indicia corresponding to operational context for each region, one or more active GUIs and one or more visual indicia of dynamic operational data. The data input by operator 118 may be stored in storage 165 and may be accessed by processor 104 of DCS 102 when displaying the desktop 200 in step 502.

In step 504, the operator 118 may use the pointer 260 to pan or move the viewable area 250 of the desktop 200 and thereby view new viewable area 350 of the desktop 200, as defined by the user's commands or input. In step 506, the operator 118 may activate a region, such as region 302, using the pointer 260. In step 508, in response to the aforementioned user activation of region 302, the processor 104 of DCS 102 may enlarge or maximize the active visual indicia 306 of active GUIs of the region, resulting in the display of active GUIs 402, 404. In step 510, the processor 104 of DCS 102 may also initiate the active GUIs 402, 404 to accept user input.

In step 512, the operator 118 may interact with the active graphical user interfaces 402, 404, such as inputting data into, and receiving data from, the active GUIs 402, 404. In step 514, the operator 118 may activate the region 302 a second time, similar to the first user activation. In step 516, in response to the aforementioned user activation of region 302, the processor 104 of DCS 102 may downsize or minimize the active visual indicia 306 of active GUIs of the region, returning the appearance of desktop 200 to that shown in FIG. 3. Subsequently, control flows back to step 502.

While various disclosed embodiments have been described above, it should be understood that they have been presented by way of example only, and not limitation. Numerous changes to the subject matter disclosed herein can be made in accordance with this Disclosure without departing from the spirit or scope of this Disclosure. In addition, while a particular feature may have been disclosed with respect to only one of several implementations, such feature may be combined with one or more other features of the other implementations as may be desired and advantageous for any given or particular application.

The terminology used herein is for the purpose of describing particular embodiments only and is not intended to be limiting. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof are used in either the detailed description and/or the claims, such terms are intended to be inclusive in a manner similar to the term “comprising.”

As will be appreciated by one skilled in the art, the subject matter disclosed herein may be embodied as a system, method or computer program product. Accordingly, this Disclosure can take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, this Disclosure may take the form of a computer program product embodied in any tangible medium of expression having computer usable program code embodied in the medium.

Any combination of one or more computer usable or computer readable medium(s) may be utilized as the non-transitory machine readable storage media. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include non-transitory media including the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CDROM), an optical storage device, or a magnetic storage device.

Computer program code for carrying out operations of the disclosure may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The Disclosure is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a physical computer-readable storage medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

We claim:

1. A method for providing an operational context-based desktop environment for a physical system, comprising:
displaying a desktop comprising a plurality of regions, each of the plurality of regions representing a different operational context of the physical system,
wherein the plurality of regions include:
visual indicia corresponding to their operational context,
visual indicia of one or more active graphical user interfaces corresponding to the operational context, and
visual indicia of dynamic operational data corresponding to the operational context, and
responsive to user activation of a first region selected from the plurality of regions, enlarging the active graphical user interfaces corresponding to the operational context of the first region.

2. The method of claim 1, wherein the step of enlarging the active graphical user interfaces further comprises initiating the active graphical user interfaces to accept user' input.

3. The method of claim 2, further comprising:
responsive to a subsequent user activation of the first region, downsizing the active graphical user interfaces corresponding to the operational context of the first region.

4. The method of claim 1, wherein the visual indicia corresponding to the operational context of the plurality of regions comprises at least one of text and an image.

5. The method of claim 4, wherein the visual indicia of one or more active graphical user interfaces corresponding to the operational context comprises at least one of text and an image.

6. The method of claim 4, wherein the visual indicia of one or more active graphical user interfaces corresponding to the operational context comprises a thumbnail image of the one or more active graphical user interfaces.

7. The method of claim 1, wherein the plurality of regions are arranged according to a physical layout of the physical system or as a flow sheet reflecting an order of process steps for a process run by the physical system.

8. A control system, comprising:
a virtual desktop environment including a display configured for displaying a desktop comprising a plurality of regions, each of the plurality of region representing a different operational context of a physical system, wherein the plurality of regions include:
visual indicia corresponding to their operational context,
visual indicia of one or more active graphical user interfaces corresponding to the operational context, and
visual indicia of dynamic operational data corresponding to the operational context;
a non-transitory machine readable storage media for storing dynamic operational data from the physical system, and
a processor communicably coupled to said machine readable storage media and to a plurality of devices associated with the physical system, wherein responsive to a user' activation of a first region selected from the plurality of regions, the processor enlarging the active graphical user interfaces corresponding to the operational context of the first region.

9. The control system of claim 8, wherein the non-transitory machine readable storage comprises a Structured Query Language (SQL) database stored in a SQL server.

10. The control system of claim 8, wherein the step of enlarging the active graphical user interfaces further comprises initiating the active graphical user interfaces to accept user input.

11. The control system of claim 10, further comprising:
responsive to a second user activation of the region, downsizing the active graphical user interfaces corresponding to the operational context of the first region.

12. The control system of claim 8, wherein the visual indicia corresponding to the operational context of the first region comprises at least one of text and an image.

13. The control system of claim 12, wherein the visual indicia of one or more active graphical user interfaces corresponding to the operational context comprises at least one of text and an image.

14. The control system of claim 12, wherein the visual indicia of one or more active graphical user interfaces corresponding to the operational context comprises a thumbnail image of the one or more active graphical user interfaces.

15. The control system of claim 8, wherein the plurality of regions are arranged according to a physical layout of the physical system or as a flow sheet reflecting an order of process steps for a process run by the physical system.

16. Machine readable storage, comprising:
a non-transitory machine readable storage media having code stored therein, said code including executable instructions, which, when executed by a computing device, cause the computing device to implement an operational context-based desktop environment for a physical system, said code including:
code for displaying a plurality of regions on a display, each of the plurality of regions representing a different operational context of the physical system, wherein the plurality of region include:
visual indicia corresponding to their operational context,
visual indicia of one or more active graphical user interfaces corresponding to the operational context; and
visual indicia of dynamic operational data corresponding to the operational context; and
responsive to user activation of a first region selected from the plurality of regions, code for enlarging the active graphical user interfaces corresponding to the operational context of the first region.

17. The machine readable storage of claim 16, further comprising code for displaying a portion of the desktop including one or more regions that are different from the plurality of regions, responsive to a panning command from a user.

18. The machine readable storage of claim 16, wherein the step of enlarging the active graphical user interfaces further comprises initiating the active graphical user interfaces to accept user input.

19. The machine-readable storage medium of claim 18, further comprising:
responsive to a second user activation of the region, code for downsizing the active graphical user interfaces corresponding to the operational context of the region.

20. The machine-readable storage medium of claim 16, wherein the code for displaying a plurality of regions arranges the plurality of regions according to a physical layout of the physical system or as a flow sheet reflecting an order of process steps for a process run by the physical system.
